(19) United States
(12) Patent Application Publication
(10) Pub. No.: US 2012/0130757 A1
(43) Pub. Date: May 24, 2012

(54) FRAMEWORK FOR VIRTUAL TEAM EFFECTIVENESS

(75) Inventors: Tushar Khosla, New Delhi (IN); Deepak Malhotra, Gurgaon (IN)

(73) Assignee: International Business Machines Corporation, Armonk, NY (US)

(21) Appl. No.: 12/951,242

(22) Filed: Nov. 22, 2010

(51) Int. Cl. G06Q 10/00

(52) U.S. Cl. 705/7.11

(57) ABSTRACT

A framework method for virtual team effectiveness. The method includes identifying members of the virtual team for a common project; determining a level of objective agreement (OA) among the virtual team members wherein OA is a shared understanding by the virtual team members of the objectives of the virtual team; determining a level of contextual appreciation (CA) among the virtual team members wherein CA is a shared understanding of an operating context under which the virtual team members operate; determining a level of style alignment (SA) among the virtual team members wherein SA is the alignment of workplace behavioral traits of the virtual team members; determining a qualitative measure of virtual team effectiveness (VTE) according to the relationship: VTE=OA*CA*SA. Also disclosed is a service method and a computer program product.

### BACKGROUND

The present invention relates to the field of virtual teaming and, more particularly, relates to enhancing the effectiveness of virtual teams and to this end proposes a framework for enabling individual team members to contribute to virtual team effectiveness.

With the world embracing the concept of global village, virtual teams have become a norm for all globally dispersed organizations. In the absence of an accelerated framework for enhancing virtual team effectiveness, the team performance is suboptimal, thereby costing organizations in rework, effort wastage, quality concerns, de-motivated employees and often customer dissatisfaction. A typical organization response is focused around enhanced governance and management intervention, which is costly but may not be effective. Another option of maintaining the team with the same team members because it is felt that the team gels well may restrict flexibility and may not be possible in all situations.

### BRIEF SUMMARY

The various advantages and purposes of the exemplary embodiments as described above and hereafter are achieved by providing, according to a first aspect of the exemplary embodiments, a framework method for virtual team effectiveness. The method includes identifying members of the virtual team for a common project; determining a level of objective agreement (OA) among the virtual team members wherein OA is a shared understanding by the virtual team members of the objectives of the virtual team; determining a level of contextual appreciation (CA) among the virtual team members wherein CA is a shared understanding of an operating context under which the virtual team members operate; determining by a computer processor a level of style alignment (SA) among the virtual team members wherein SA is the alignment of workplace behavioral traits of the virtual team members; and determining a qualitative measure of virtual team effectiveness (VTE) according to the relationship:

VTE=OA*CA*SA.

According to a second aspect of the exemplary embodiments, there is provided a method for providing a virtual team effectiveness framework service to a client. The method includes: responsive to input from the virtual team members or client, identifying members of the virtual team working on a common project; responsive to input from the virtual team members or client, determining a level of objective agreement (OA) among the virtual team members wherein OA is a shared understanding by the virtual team members of the objectives of the virtual team; responsive to input from the virtual team members or client, determining a level of contextual appreciation (CA) among the virtual team members and stakeholders wherein CA is a shared understanding of an operating context under which the virtual team members operate; responsive to input from the virtual team members or client, determining by a computer processor a level of style alignment (SA) among the virtual team members wherein SA is the alignment of workplace behavioral traits of the virtual team members; and determining a qualitative measure of virtual team effectiveness (VTE) according to the relationship: VTE=OA*CA*SA.

According to a third aspect of the exemplary embodiments, there is provided a computer program product for a framework for virtual team effectiveness, the computer program product including: a computer readable storage medium having computer readable program code therewith, the computer readable program code including: responsive to input received, computer readable program code configured to input members of the virtual team working on a common project; responsive to input received, computer readable program code configured to determine a level of objective agreement (OA) among the virtual team members wherein OA is a shared understanding by the virtual team members of the objectives of the virtual team; responsive to input received, computer readable program code configured to determine a level of contextual appreciation (CA) among the virtual team members and stakeholders wherein CA is a shared understanding of an operating context under which the virtual team members operate; responsive to input received, computer readable program code configured to determine a level of style alignment (SA) among the virtual team members wherein SA is the alignment of workplace behavioral traits of the virtual team members; and computer readable program code configured to determine a qualitative measure of virtual team effectiveness (VTE) according to the relationship: VTE=OA*CA*SA.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a self style profile for a virtual team member.

FIG. 2 is a style profile for a stakeholder as viewed by the virtual team member.

FIG. 3 is a combined style profile of virtual team member and stakeholder.

FIG. 4 is a combined style profile of virtual team member and stakeholder showing adjustments by the virtual team member.

FIG. 5 is a block diagram that illustrates one exemplary hardware environment of the present invention.

### DETAILED DESCRIPTION

The present inventors have proposed an easily deployable framework that can help enhance virtual team effectiveness, allow for quick learning and enable teams to reach their optimal effectiveness in a short duration.

Exemplary embodiments disclose the overall framework for enhancing virtual team effectiveness that can be deployed in any context and involves team members working together in geographically, spread out locations. The exemplary embodiments proceed on the premise that the virtual team members are individually competent and have very little social or physical interlace apart from meeting in a work environment in a physically dispersed manner. The interaction between virtual team members may be through electronic mail (email), telephone conferences or by video conference. Face to face interaction between virtual team members is not common.

The proposed framework is focused on providing easily deployable and effective tools for working professionals and is based on objective agreement, contextual appreciation and style alignment.

Objective agreement is a shared understanding by the virtual team members of the objectives of the virtual team. Every virtual team has some stated objectives but problems may occur when the objectives are not similarly interpreted by all of the team members or the priorities among the objectives (their weights) are not fully stated, especially to handle situations seeking tradeoffs. For example, one set of team members may consider “client satisfaction” as the most important objective (even at the cost of profit sacrifice), while another set of team members may consider “profit maximization” as the key objective. Although such situations do occur, there are well defined processes that ensure that there is a shared understanding of the objectives and their priorities among the team members. Discussions around joint metrics definition and benefit commitments to be later reflected in contracts often help define the objectives. Traditional frameworks like balance scorecard and project contract checklists may help develop objective agreements. Further, effective governance mechanisms will ensure that any changes in the objectives on account of changes in operating context or business imperatives that warrant change in team objectives will be discussed suitably and all team members informed of modifications in an appropriate manner.

Contextual appreciation is a shared understanding of the operating context under which the virtual team members operate. Contextual appreciation may also be viewed as the work environment of the virtual team members. Contextual appreciation may be defined in terms of external influencing factors, resource availability, non-negotiable constraints and technical infrastructure at disposal. A gap in the contextual appreciation between team members in the virtual environment can often lead to wrong assumptions, planning and commitments. Contractual terms and conditions and effective and regular sharing of information can help enhance the shared contextual appreciation by the team members of the virtual team. Well structured project kick-off and detailed on-hoarding orientation material helps in developing better contextual appreciation.

Style alignment is the alignment of workplace behavioral traits of the virtual team members. Style may be defined as a person's specific observable preferred workplace behavioral traits that may be the outcome of personality, values, attitude, or cultural leanings. Style misalignment among team members in virtual settings may often emerge as style differences and are not so obvious to the team members unless they make a conscious effort to understand the style of their counterparts and map their counterparts' style against their own for appreciation of gaps and alignment.

The relationship between virtual team effectiveness, objective agreement, contextual appreciation and style alignment may be expressed by the VTE Equation as follows:

VTE=OA*CA*SA where

VTE is the virtual team effectiveness;

OA is the objective agreement;

CA is the contextual appreciation; and

SA is the style alignment.

There are two things that should be understood with respect to the VTE equation. First, the VTE equation expresses a relationship and the values for virtual team effectiveness, objective agreement, contextual appreciation and style alignment are qualitative values and not mathematical numbers. Second, objective agreement, contextual appreciation and style alignment have a multiplicative relationship so a low value for either of these has a multiplier effect on virtual team effectiveness. For high virtual team effectiveness, all of objective agreement, contextual appreciation and style alignment should have high values. Neglecting or having a low score in one of these elements will have a lowering impact on the overall virtual team effectiveness and a zero score in any of these dimensions would mean an overall zero in effectiveness irrespective of the score in the other two dimensions.

High levels of objective agreement and contextual appreciation are possible by better planning and effective communication in the early stage of virtual team formation. Any gaps in these factors may get revealed on their own and may be prominently addressed by the management or the virtual team members themselves. However, it has been observed that even after high levels of objective agreement and contextual appreciation, the effectiveness of the virtual team may still be low and one reason for this may be attributed to the misalignment of styles between a team member and the stakeholders. In this context, the stakeholder is a virtual team member but one who receives the roles and responsibilities of another virtual team member. The stakeholder may be, for example, a team-lead, module leader or even a client.

Style alignment may be enhanced so that overall virtual team effectiveness improves. The following discussion focuses on a methodology for enhancing style alignment.

There are three categories of style components: decision making, relationship view and information processing. These three categories may be subdivided into nine components. Decision making has three components, namely, participation in decisions, risk averseness and flexibility. Relationship view similarly has three components, namely, authority dependence, authority focus and work focus. Information processing also has three components, namely, process focus, reading type and information base.

The three categories and nine components of style are shown in the list below:

I. Decision Making:
1. Participation in decisions: Participative −> Decisive

Participative—team member involves other team members in making decisions
Decisive—team member makes decisions on his own but may take opinion of
others on a need basis

2. Risk averseness: Enterprising −> Risk averse

Enterprising—team member has the willingness to undertake new projects and
gets excited in driving new things
Risk averse—team member seeks precedence, is not willing to try new things and
avoids risk with any new ventures

3. Flexibility: Tentative −> Rigid

Tentative—team member open to changing his opinions and may not follow all
his commitments
Rigid—team member is firm with his decisions and opinions

II. Relationship view:
4. Authority dependence: Authority dependent −> Independent

Authority dependent—team member seeks permission/approval even for things
within own jurisdiction or power of authority
Independent—team member makes decisions and exercises allowed power
independently

5. Authority focus: Boss focus −> Organization focus

Boss focus—team member considers boss as the key customer and does not
questions his judgement or decisions
Organization focus—team member considers eventual loyalty to the organization
and is open to sharing his difference of opinion with the boss

6. Work focus: Work centric −> People focused

Work centric—team member focus on accomplishments of the task and is not
consciously inclined towards relationship building
People focused—team member focuses on relationship building and considers
people view in all decisions

III. Information Processing:
7. Process focus: Process based −> Outcome oriented

Process based—team member focuses on the prescribed process of achieving the
result and considers process compliance as prime
Outcome oriented—team member focuses on the end result rather than the
process and is amenable to process deviations if backed by rational argument
linked to desired outcome

8. Reading type: Reading −> Listening

Reading—team member likes to read detailed content in written form as preferred
mode of information gathering
Listening—team member likes to listen to opinions, discussions and gather
information primarily through conversations

9. Information base: Data backed −> Intuitive

Data backed—team member prefers to trust information that is tangible, concrete,
backed with data from credible sources
Intuitive—team member prefers to focus on the overall framework and proposal
and rely on it “sounding good”

The nine components of style are defined in terms of the extreme characteristics as defined below. These characteristics present a continuum, wherein an individual can fall at any level in between the extremes. It should not be inferred that any style characteristics or combination is more effective or preferred over any other style characteristics or combination.

For example, considering the first category of “decision making” in the list above, there are three separate components, namely, participation in decisions, risk averseness and flexibility. Taking the first subcategory of “participation in decisions”, the characteristics may be “participative” or “decisive” or any place in between as indicated by the nomenclature “Participative->Decisive”. Similarly, in the second subcategory of “risk averseness”, the characteristics may be “enterprising” or “risk averse” or any place in between as indicated by the nomenclature “enterprising->risk averse”. In the third category of “flexibility”, the characteristics may be “tentative” or “rigid” or any place in between as indicated by the nomenclature “tentative->rigid”. The rest of the list above may be read the same way.

Recognizing that style characteristics may vary between team members and stakeholders, the present inventors have proposed a methodology for dealing with these variations and enhancing the style alignment value so as to maximize virtual team effectiveness. The methodology includes a multi-step approach of: developing a self style profile, identifying key stakeholders for style alignment, developing the style profile of key stakeholders, overlaying the style of the virtual team members that interact with the key stakeholders, performing a profile gap analysis, and acting on the profile gap.

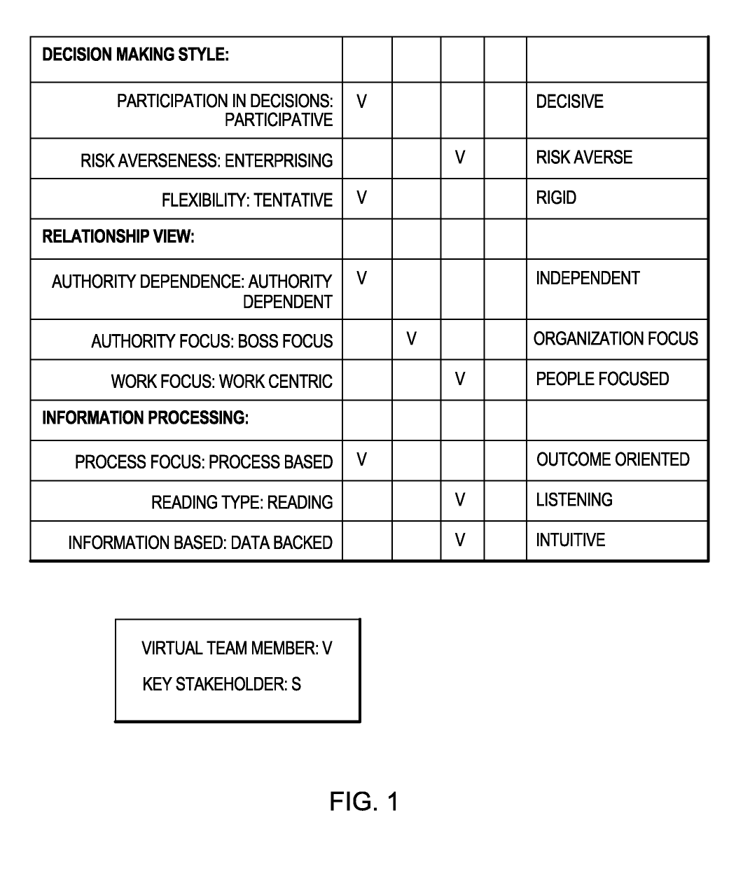

Each of these steps will now be considered in detail. First, developing a self style profile. This may include examining one's own behavior and marking one's preferred style on the nine style components in the profile map. Often this will require self observation and confirmation with the virtual team members or friends of the virtual team members. A self style profile is shown in FIG. 1 for one virtual team member.

Next, Identifying key stakeholders for style alignment. The key stakeholder is a person whose performance would be significantly affected by, or related to, the performance of a virtual team member. For the purpose of style alignment, the key stakeholder may be the virtual team member's counterpart in another location, whom one interacts with most for delivering one's role and responsibilities within the virtual team. The key stakeholder could be a team-lead or module leader as the case may be. It is also within the scope of the present exemplary embodiments for the key stakeholders to be customers or clients of the virtual team member. There is no limit to the number of key stakeholders for style alignment, but in practice up to three key stakeholders would be optimum.

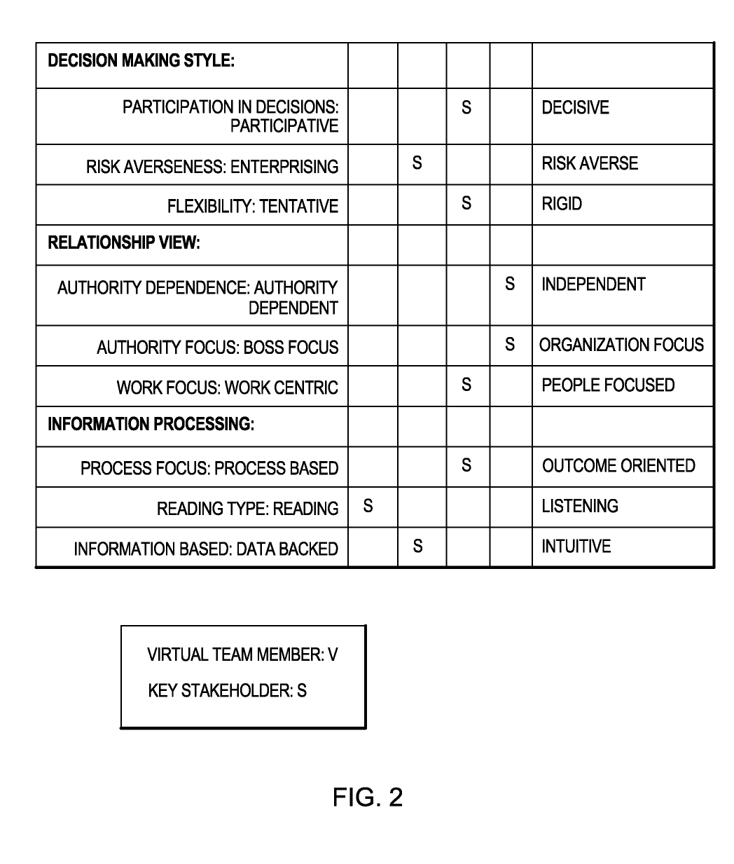

Next, developing the style profile of key stakeholder(s). This may require conscious observation of the key stakeholder behavior during early interactions and joint meetings to develop hypotheses and confirm in some subsequent interactions. For example, if the key stakeholder always asks for presentation material much in advance of the meeting and comes well prepared, he is of “reading” type, compared to one who will open presentation material during the meeting for the first time. If he does not take any decisions during meetings, but defers to checking with his boss, he has high “authority dependence, or if defers to his manager or team lead in every argument or suggestion, he is “boss focused”. A style profile for one key stakeholder is shown in FIG. 2.

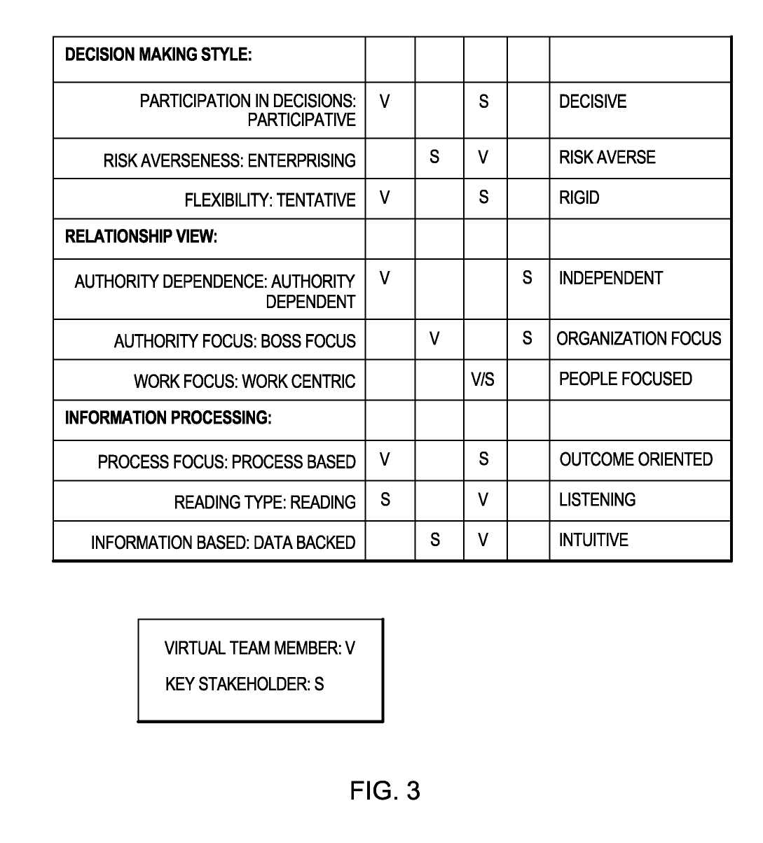

It is advantageous to map the style profile of each key stakeholder over the style profile of each virtual team member that the key stakeholder interacts with. FIG. 3 shows the style profile of the virtual team member in FIG. 1 with the style profile of the key stakeholder in FIG. 2 on the same style profile. This may be done by doing separate style profiles as shown in FIGS. 1 and 2 and then merging them together. More simply, the virtual team member may do his own style profile as shown in FIG. 1 and then mapping the style profile for the key stakeholder onto his style profile to result in the style profile shown in FIG. 3. The virtual team member would have to do this type of profile mapping for each pair of virtual team member and key stakeholder. That is, the style profile in FIG. 3 represents the style profile for one virtual team member and one key stakeholder. If there were other key stakeholders, the virtual team member would have to do a similar style profile analysis for the other key stakeholders.

The next step is performing a profile gap analysis. Those components wherein there is gap between the virtual team member self profile and key stakeholder profile provides scope for a conflict in style leading to a suboptimal outcome. The impact will depend upon the intensity of the gap, for example, authority dependent paired with independent, process locus paired with outcome oriented or enterprising paired with risk averse, leading to frustration and disengagement by team members and a consequent suboptimal outcome. According to the methodology of the exemplary embodiments, Identifying those components among the nine should be done where there is more than one degree of gap between the virtual team member self profile and key stakeholder profile.

Lastly, acting on the gap. Being conscious of the style differences between the virtual team member and the key stakeholders will help one make adjustments in communication preferences and have enhanced appreciation of the other person's perspective. Further, the assumption is that one has greater influence to adjust one's own style than to convince others to do so. Accordingly, being conscious of the gap, the virtual team member needs to adjust his style to bring his style closer to that of the key stakeholder. There are certain suggested measures that can be taken to adjust one's style closer to that of the key stakeholder. Some such measures for each of the style components for decision making, relationship view and information processing are presented in the tables below.

Referring again to FIG. 3, it can be seen that for the category “decision making style”, (i) the virtual team member has a “participative” style while the key stakeholder leans to a “decisive” style in the first subcategory, (ii) the virtual team member and key stakeholder are in the middle of the continuum between “enterprising” and “risk averse” in the second subcategory, and (iii) the virtual team member has a “tentative” style while the key stakeholder leans to a “rigid” style” in the third subcategory.

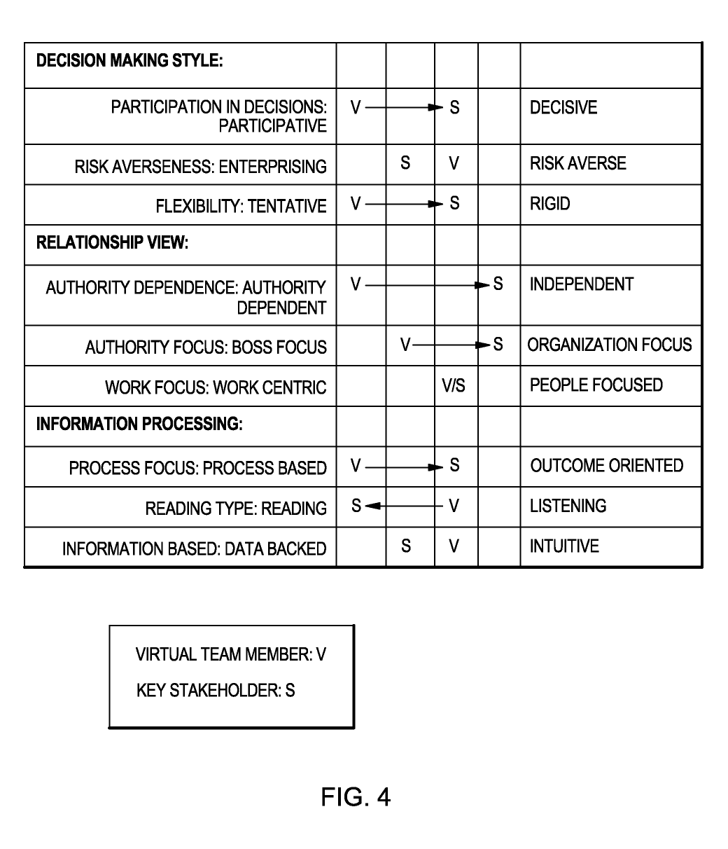

Referring now to FIG. 4, a profile gap analysis has been performed and actions have been performed to obtain improved style alignment. In the first subcategory under “decision making style”, the virtual team member needs to move his own style from “participative” towards “decisive”. The virtual team member may perform any of the suggested measures in the “decisive” component of the “Decision Making:Proposed Measures for Stakeholder Tilt” table to move his style towards “decisive”. One such measure might be to make sure that the case is presented well with all required information to facilitate decision making. In the second subcategory under “decision making style”, the virtual team member need not adjust his style as the virtual team member and key stakeholder have similar styles and thus there is minimal style misalignment. In the third category under “decision making style”, the virtual team member needs to move his own style from “tentative” towards “rigid”. The virtual team member may perform any of the suggested measures in the “rigid” component of the “Decision Making:Proposed Measures for Stakeholder Tilt” table to move his style towards “decisive”. One such measure might be to delay the need for decision making until all options are clear and the decision can no longer be delayed.

A similar profile gap analysis actions may be performed for the remaining categories and subcategories of FIG. 4. Once the profile gap analysis and actions are performed for the virtual team member and key stakeholder, the process is complete for this pair of virtual team member and key stakeholder. This virtual team member may perform a similar profile gap analysis and act on it for another key stakeholder if there is another key stakeholder that this virtual team member interacts with. Other virtual team members may also perform ea profile gap analysis and act on it for key stakeholders that these other virtual team members interact with.

The proposed framework is directed at professionals working across industries and geographies. Exemplary embodiments of the proposed framework are easy to apply and effective in its usage as it is based primarily on experiential sharing with requisite management theoretical support.

| | |
|---|---|
| Stakeholder Tilt | Suggested Measures |

Decision Making: Proposed Measures for Stakeholder Tilt

| | |
|---|---|
| Participative | Allow for the longer time for decision making to accommodate wider |
| | consultations. |
| | Call meetings with wider attendance, and facilitate consensus building. |
| | Sell recommendations to get wider buy-in. |
| | Follow-up with the minutes of the meeting documenting decisions taken. |
| Decisive | Make sure that the case is presented well with all required information to |
| | facilitate decision making. |
| | Examine level of decisions that he needs to take - strategic or tactical. |
| | Take decisions yourself that are corollaries of decisions taken and not seek |
| | reconfirmations again and again. |
| Enterprising | Make sure that the uniqueness of the proposal is presented upfront. |
| | Clearly document the risks involved and make the downside known. |
| | Be clear about the roles and responsibilities with regard to execution |
| | activities, including reward/blame sharing mechanism. |
| Risk Averse | Present precedence or similar case studies to support decision. |
| | Clearly articulate the extent of downside. |
| | Present proposition to wider audience and ask to articulate apprehensions. |
| | Make it known that doing nothing may actually be a greater risky proposition. |
| Tentative | Clearly articulate the need for making a choice and implication of the |
| | commitment made. |
| | Confirm the decision taken in written form, before acting on the decisions- in |
| | terms of committing money or resources. |
| | Be more empowered to take decisions by taking other stakeholders in |
| | confidence. |
| Rigid | Delay the need for decision making until all options are clear and the |
| | decisions can no longer be delayed. |
| | Clearly delineate the assumptions made during decision making with tacit |
| | understanding of revisiting decisions in the events of assumptions coming to |
| | be false. |
| | Keep buffer while agreeing on the deadlines as these are often non-negotiable. |

Relationship View: Proposed Measures for Stakeholder Tilt

| | |
|---|---|
| Authority Dependent | Help prepare case for taking proposal to the boss. |
| | Plan for delay in decision making. |
| | Establish rapport with the Authority. |
| Independent | Present your case in logical, rational and well prepared manner. |
| | Ensure decision asked for is within the powers. |
| | Make sure the case is presented to highlight aspects of high priority to |
| | decision maker. |
| Boss Focus | Relate proposals to the priorities as articulated by the boss. |
| | Make sure that the proposals do not seem to contradict stakeholders' boss |
| | views or interests. |
| | Let stakeholder own aspects that are in line with his interpretation of |
| | boss' views/interests and not necessarily in sync with yours. |
| Organization Focus | Present all proposals/arguments in terms of benefit to organizations. |
| | Link rational arguments to organization values, objectives and priorities. |
| | Reinforce Organization interest as paramount and binding force among |
| | stakeholders. |
| Work Centric | Keep conversations centric around work - quality and milestones. |
| | Let meetings get over early if work is over- gift additional time. |
| | Present Result Status, alternate plan to completion, and reasons for delay |
| | in that order. |
| People Focused | Envisage impact of potential decision on impacted stakeholders and have |
| | mitigation plan. |
| | Check key stakeholders emotions about decision in advance. |
| | Present proposal as best option available that meets business objectives |
| | and keep people interest impacted the least. |

Information Processing: Proposed Measures for Stakeholder Tilt

| | |
|---|---|
| Reading | Make detailed documentation of the argument, including stating what looks |
| | obvious to you. |
| | Send the material for perusal much in advance to decision making meeting. |
| | Be ready to have discussion on the choice of words and be open to make |
| | modifications. |
| | Be prepared to submit detailed minutes of the meetings. |
| Listening | Prepare to present the argument in well structured presentation form, while |
| | managing complexity and avoiding data overload. |
| | Keep all data handy to be used during intense question-answer sessions. |
| | Keep meeting for longer duration to allow for conclusive dialogue. |
| Process Based | Be clear about the prescribed applicable process. |
| | Carry evidence to prove that the process was well adhered to - including |
| | reporting on process metrics. |
| | Give process sufficient prominence while presenting results. |
| Outcome Oriented | Initiate presentation by articulating outcomes (proposed and status). |
| | Present proposals (including those seeking deviations from processes) in |
| | terms of impact on outcomes. |
| | Clearly delineate the dependencies and influencing factors that may impact |
| | intended outcomes. |
| Data Backed | Be prepared to back all of your hypotheses with data from credible sources. |
| | Use of sophisticated trend analysis and statistical tools wherever possible |
| | will help. |
| | Make effort to ensure the data used in analysis is recent. |
| Intuitive | Be able to present the overall picture in visionary terms. |
| | Be able to link the proposal to the overall framework. |
| | The onus of ensuring that execution of the proposal is well thought out and |
| | details taken care of is with you. |

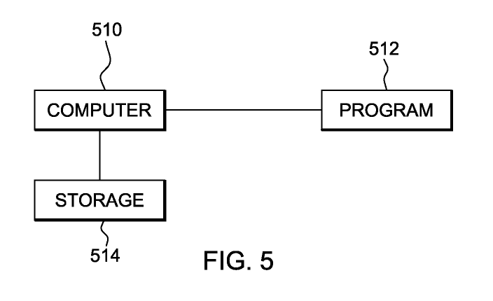

The program environment in which a present embodiment of the invention may be executed illustratively incorporates a general-purpose computer or a special purpose device such as a hand-held computer. FIG. 5 is a block diagram that illustrates one exemplary hardware environment of the present invention. The exemplary embodiments may be implemented using a computer 510 comprised of microprocessor means, random access memory (RAM), read-only memory (ROM) and other components. The computer may be a personal computer, mainframe computer or other computing device. Resident in the computer 510, or peripheral to it, will be a storage device 514 of some type such as a hard disk drive, floppy disk drive, CD-ROM drive, tape drive or other storage device.

Generally speaking, the software implementation of the exemplary embodiments, program 512 in FIG. 5, is tangibly embodied in a computer-readable medium such as one of the storage devices 514 mentioned above. The program 512 comprises instructions which, when read and executed by the microprocessor of the computer 510 causes the computer 510 to perform the steps necessary to execute the steps or elements of the exemplary embodiments.

As will be appreciated by one skilled in the art, aspects of the exemplary embodiments may be embodied as a system, method, service method or computer program product. Accordingly, aspects of the exemplary embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the exemplary embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the exemplary embodiments may be written in any combination of one or more programming languages, including an object oriented programming language such as Java, Smalltalk, C++ or the like and conventional procedural programming languages, such as the “C” programming language or similar programming languages or even Microsoft Excel/Access. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the exemplary embodiments have been described above with reference to flowchart illustrations and/or block diagrams of methods, apparatus (systems) and computer program products according to the exemplary embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the Figures illustrate the architecture, functionality, and operation of possible implementations of systems, methods, service methods and computer program products according to the exemplary embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A framework method for virtual team effectiveness comprising:
identifying members of the virtual team for a common project;
determining a level of objective agreement (OA) among the virtual team members wherein OA is a shared understanding by the virtual team members of the objectives of the virtual team;
determining a level of contextual appreciation (CA) among the virtual team members wherein CA is a shared understanding of an operating context under which the virtual team members operate;
determining by a computer processor a level of style alignment (SA) among the virtual team members wherein SA is the alignment of workplace behavioral traits of the virtual team members; and
determining a qualitative measure of virtual team effectiveness (VTE) according to the relationship:
VTE=OA*CA*SA.

2. The framework method of claim 1 further comprising improving the level of at least one of OA, CA and SA to improve virtual team effectiveness.

3. The framework method of claim 1 further comprising improving OA by improving agreement of team objectives by the virtual team members by a process.

4. The framework method of claim 1 further comprising improving CA by improving the contextual appreciation by the team members by a process.

5. The framework method of claim 1 further comprising responsive to input by one virtual team member of the virtual team members, identifying key stakeholders of the one virtual team member among the virtual team members and responsive to input from the one virtual team member, improving SA by determining by a computer processor a gap between the workplace behavioral traits displayed by the one virtual team member and the identified key stakeholders and closing the gap.

6. The framework method of claim 1 further comprising improving SA by:
responsive to input by one virtual team member of the virtual team members, developing a style profile for the one virtual team member;
responsive to input by the one virtual team member, identifying key stakeholders of the one virtual team member;
responsive to input by the one virtual team member, developing style profiles for the key stakeholders;
responsive to input by the one virtual team member, overlaying by a computer processor the style profiles of the one virtual team member and the key stakeholders;
responsive to input by the one virtual team member, performing by a computer processor a profile gap analysis to determine misalignment of style profiles between the one virtual team member and the key stakeholders;
responsive to input by the one virtual team member, acting on the profile gap to reduce the misalignment of style profiles between the one virtual team member and the key stakeholders.

7. The framework method of claim 1 further comprising improving SA by:
responsive to input by one virtual team member of the virtual team members, developing a style profile for the one virtual team member;
responsive to input by the one virtual team member, identifying a key stakeholder of the one virtual team member;
responsive to input by the one virtual team member, developing a style profile for the key stakeholder;
responsive to input by the one virtual team member, overlaying by a computer processor the style profiles of the one virtual team member and the key stakeholder;
responsive to input by the one virtual team member, performing by a computer processor a profile gap analysis to determine misalignment of style profiles between the one virtual team member and the key stakeholder;
responsive to input by the one virtual team member, acting on the profile gap to reduce the misalignment of style profiles between the one virtual team member and the key stakeholder; and
repeating the steps of identifying, developing a style profile for the key stakeholder, overlaying, performing and acting until all key stakeholders have been identified and the profile gap has been acted upon.

8. The framework method of claim 6 further comprising:
defining the style profiles according to the following three categories and nine components:
I. Decision Making:
1. Participation in decisions: Participative->Decisive
2. Risk averseness: Enterprising->Risk averse
3. Flexibility: Tentative->Rigid
II. Relationship view:
4. Authority dependence: Authority dependent->Independent
5. Authority focus: Boss focus->Organization focus
6. Work focus: Work centric->People focused
III. Information Processing:
7. Process focus: Process based->Outcome oriented
8. Reading type: Reading->Listening
9. Information base: Data backed->Intuitive

9. The framework method of claim 8 wherein reducing the style profile misalignment includes the style profile of the one virtual team member aligning with the style profile of the key stakeholders on the Decision Making category of the style profile.

10. The framework method of claim 8 wherein the style profile of the one virtual team member aligning with the style profile of the key stakeholders on the following three components of Decision Making:
Participation in decisions: Participative->Decisive
Risk averseness: Enterprising->Risk averse
Flexibility: Tentative->Rigid

11. The framework method of claim 8 wherein reducing the style profile misalignment includes the style profile of the one virtual team member aligning with the style profile of the key stakeholders on the Relationship View category of the style profile.

12. The framework method of claim 11 wherein the style profile of the one virtual team member aligning with the style profile of the key stakeholders on the following three components of Relationship view:
Authority dependence: Authority dependent->Independent
Authority focus: Boss focus->Organization focus
Work focus: Work centric->People focused

13. The framework method of claim 8 wherein reducing the style profile misalignment includes the style profile of the one virtual team member aligning with style profile of the key stakeholders on the Information Processing category of the style profile.

14. The framework method of claim 13 wherein the style profile of the one virtual team member aligning with the style profile of the key stakeholders on the following three components of Information Processing:
Process focus: Process based->Outcome oriented
Reading type: Reading->Listening
Information base: Data backed->Intuitive

15. A method for providing a virtual team effectiveness framework service to a client comprising:
responsive to input from the virtual team members or client, identifying members of the virtual team working on a common project;
responsive to input from the virtual team members or client, determining a level of objective agreement (OA) among the virtual team members wherein OA is a shared understanding by the virtual team members of the objectives of the virtual team;
responsive to input from the virtual team members or client, determining a level of contextual appreciation (CA) among the virtual team members and stakeholders wherein CA is a shared understanding of an operating context under which the virtual team members operate;
responsive to input from the virtual team members or client, determining by a computer processor a level of style alignment (SA) among the virtual team members wherein SA is the alignment of workplace behavioral traits of the virtual team members; and
determining a qualitative measure of virtual team effectiveness (VTE) according to the relationship:
VTE=OA*CA*SA.

16. The method of claim 15 further comprising responsive to input by the client or one virtual team member of the virtual team members, identifying key stakeholders of the one virtual team member among the virtual team members and responsive to input from the one virtual team member or client, improving SA by determining by a computer processor a gap between the workplace behavioral traits displayed by the one virtual team member and the identified key stakeholders and closing the gap.

17. The method of claim 15 further comprising improving SA by:
responsive to input by the client or one virtual team member of the virtual team members, developing a style profile for the one virtual team member;
responsive to input by the client or the one virtual team member, identifying key stakeholders of the one virtual team member;
responsive to input by the client or the one virtual team member, developing style profiles for the key stakeholders;
responsive to input by the client or the one virtual team member, overlaying by a computer processor the style profiles of the one virtual team member and the key stakeholders;
responsive to input by the client or the one virtual team member, performing by a computer processor a profile gap analysis to determine misalignment of style profiles between the one virtual team member and the key stakeholders;
responsive to input by the client or the one virtual team member, acting on the profile gap to reduce the misalignment of style profiles between the one virtual team member and the key stakeholders.

18. The method of claim 15 further comprising improving SA by:
responsive to input by the client or the one virtual team member of the virtual team members, developing a style profile for the one virtual team member;
responsive to input by the client or the one virtual team member, identifying a key stakeholder of the one virtual team member;
responsive to input by the client or the one virtual team member, developing a style profile for the key stakeholder;
responsive to input by the client or the one virtual team member, overlaying by a computer processor the style profiles of the one virtual team member and the key stakeholder;
responsive to input by the client or the one virtual team member, performing by a computer processor a profile gap analysis to determine misalignment of style profiles between the one virtual team member and the key stakeholder;
responsive to input by the client or the one virtual team member, acting on the profile gap to reduce the misalignment of style profiles between the one virtual team member and the key stakeholder; and
repeating the steps of identifying, developing a style profile for the key stakeholder, overlaying, performing and acting until all key stakeholders have been identified and the profile gap has been acted upon.

19. A computer program product for a framework for virtual team effectiveness, the computer program product comprising:
a computer readable storage medium having computer readable program code therewith, the computer readable program code comprising:
responsive to input received, computer readable program code configured to input members of the virtual team working on a common project;
responsive to input received, computer readable program code configured to determine a level of objective agreement (OA) among the virtual team members wherein OA is a shared understanding by the virtual team members of the objectives of the virtual team;
responsive to input received, computer readable program code configured to determine a level of contextual appreciation (CA) among the virtual team members and stakeholders wherein CA is a shared understanding of an operating context under which the virtual team members operate;
responsive to input received, computer readable program code configured to determine a level of style alignment (SA) among the virtual team members wherein SA is the alignment of workplace behavioral traits of the'virtual team members; and
computer readable program code configured to determine a qualitative measure of virtual team effectiveness (VTE) according to the relationship:
VTE=OA*CA*SA.
